(19) United States
(12) Patent Application Publication
(10) Pub. No.: US 2010/0051428 A1
(43) Pub. Date: Mar. 4, 2010

(54) SWITCH AND ESD PROTECTION DEVICE

(76) Inventor: Tamio IKEHASHI, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/552,741

(22) Filed: Sep. 2, 2009

(30) Foreign Application Priority Data
Sep. 3, 2008 (JP) 2008-226135

(51) Int. Cl. H01H 57/00

(52) U.S. Cl. 200/181

(57) ABSTRACT

A switch includes a first electrode provided on a substrate, an anchor provided on the substrate, a movable structure which is supported by the anchor, provided above the first electrode to be extended from the anchor in a direction, formed of a conductor, and moves downwards, and a contact member which is attached to an edge of the movable structure, formed of a conductor, and warps toward the first electrode.

### CROSS-REFERENCE TO RELATED APPLICATIONS

This application is based upon and claims the benefit of priority from prior Japanese Patent Application No. 2008-226135, filed Sep. 3, 2008, the entire contents of which are incorporated herein by reference.

### BACKGROUND

In recent years, miniaturization of a micromachine technology is advancing. As a technology included in this micromachine technology, micro-electromechanical systems (MEMS) are known. The MEMS is a technology that utilizes a semiconductor process technology to finely fabricate a movable three-dimensional structure.

As devices formed by using the MEMS, a variable capacitance, a switch, an acceleration sensor, a pressure sensor, a radio frequency (RF) filter, a gyroscope, a mirror device, and others are mainly studied and developed.

Of these devices, a MEMS switch is suitable as a high-frequency switch since it has characteristics of a small loss, good isolation, excellent linearity, and others. The MEMS switch has a small loss, because the contact resistance of a contact portion is small and the contact force of the contact portion is sufficiently increased to reduce this contact resistance.

As this type of relevant technology, a MEMS switch having a conductive dimple provided at a distal end of an electrode is disclosed (is U.S. Pat. No. 6,440,767).

### SUMMARY

According to an aspect of the present invention, there is provided a switch comprising: a first electrode provided on a substrate; an anchor provided on the substrate; a movable structure which is supported by the anchor, provided above the first electrode to be extended from the anchor in a direction, formed of a conductor, and moves downwards; and a contact member which is attached to an edge of the movable structure, formed of a conductor, and warps toward the first electrode.

According to an aspect of the present invention, there is provided a switch comprising: first and second electrodes provided on a substrate to be aligned in a first direction; a movable structure which is provided above the first and second electrodes to be extended in a second direction orthogonal to the first direction, and formed of a conductor; first and second contact members which are respectively attached to both ends of the movable structure in the first direction, formed of a conductor, and respectively warp toward the first and second electrodes; and first and second actuators which are respectively attached to both ends of the movable structure in the second direction, and drive downwards the movable structure.

According to an aspect of the present invention, there is provided an ESD protection device comprising: an electrode which is provided on a substrate and electrically connected to a first terminal of a current path of a device to be protected; a first anchor provided on the substrate; a movable structure which is supported by the first anchor, provided above the electrode to be extended from the first anchor in a first direction, formed of a conductor, moves downwards, and is electrically connected to a second terminal of the current path of the device to be protected; and a contact member which is attached to an edge of the movable structure, formed of a conductor, and warps toward the electrode.

### BRIEF DESCRIPTION OF THE SEVERAL VIEWS OF THE DRAWING

FIG. 1A is a plan view showing a structure of a MEMS switch 10 according to a first embodiment;

FIG. 1B is a cross-sectional view of the MEMS switch 10 taken along line A-A′ in FIG. 1A;

FIG. 2 is a cross-sectional view showing a manufacturing process of the MEMS switch 10;

FIGS. 3A and 3B are views for explaining an operation of the MEMS switch 10 according to the first embodiment;

FIG. 4A is a plan view showing a structure of a MEMS switch 10 according to Example 1;

FIG. 4B is a cross-sectional view of the MEMS switch 10 taken along line A-A′ in FIG. 4A;

FIG. 5 is a plan view showing a structure of a MEMS switch 10 according to Example 2;

FIG. 6A is a cross-sectional view of the MEMS switch 10 taken along line A-A′ in FIG. 5;

FIG. 6B is a cross-sectional view of the MEMS switch 10 taken along line B-B′ in FIG. 5;

FIGS. 7A and 7B are views for explaining an operation of the MEMS switch 10 according to Example 2;

FIG. 8A is a plan view showing a structure of a MEMS switch according to Example 3;

FIG. 8B is a cross-sectional view of the MEMS switch 10 taken along line A-A′ in FIG. 8A;

FIGS. 9A and 9B are views for explaining an operation of the MEMS switch 10 according to Example 3;

FIG. 10A is a plan view showing configurations of a movable structure 16 and a contact member 17 according to Example 4;

FIG. 10B is a cross-sectional view of the movable structure 16 and the contact member 17 taken along line A-A′ in FIG. 10A;

FIG. 11A is a plan view showing a configuration of an ESD protection device 60 according to a second embodiment;

FIG. 11B is a cross-sectional view of the ESD protection device 60 taken along line A-A′ in FIG. 11A;

FIG. 11C is a cross-sectional view of the ESD protection device 60 taken along line B-B′ in FIG. 11A;

FIG. 12 is a plan view showing configurations of the ESD protection device 60 and a variable capacitance device 70;

FIG. 13 is a cross-sectional view of the variable capacitance device 70 taken along line C-C′ in FIG. 12;

FIG. 14 is an equivalent circuit schematic of the ESD protection device 60 and the variable capacitance device 70;

FIGS. 15A and 15B are views for explaining an operation of the ESD protection device 60 according to the second embodiment;

FIG. 16A is a view showing how a contact member 17 is in contact with a signal line 61 when an ESD pulse is applied;

FIGS. 16B and 16C are views showing a change in distance g between the contact member 17 and the signal line 61 when the ESD pulse is applied;

FIG. 17 is a plan view showing configurations of the ESD protection device 60 and a MEMS switch 80;

FIG. 18A is a cross-sectional view of the MEMS switch 80 taken along line A-A′ in FIG. 17;

FIG. 18B is a cross-sectional view of the MEMS switch 80 taken along line B-B′ in FIG. 17;

FIG. 18C is an equivalent circuit schematic of the MEMS switch 80 and the ESD protection device 60 in FIG. 17;

FIG. 19A is a plan view showing a configuration of an ESD protection device according to Example 1;

FIG. 19B is a cross-sectional view of the ESD protection device 60 taken along line A-A′ in FIG. 19A;

FIG. 20A is a plan view showing a configuration of an ESD protection device 60 according to Example 2;

FIG. 20B is a cross-sectional view of the ESD protection device 60 taken along line A-A′ in FIG. 20A;

FIG. 21A is a plan view showing a configuration of an ESD protection device 60 according to Example 3; and

FIG. 21B is a cross-sectional view of the ESD protection device 60 taken along line A-A′ in FIG. 21A.

### DETAILED DESCRIPTION OF THE INVENTION

The embodiments of the present invention will be described hereinafter with reference to the accompanying drawings. In the description which follows, the same or functionally equivalent elements are denoted by the same reference numerals, to thereby simplify the description.

### First Embodiment

A first embodiment is an example that a MEMS structure according to the present invention is applied to a switch.

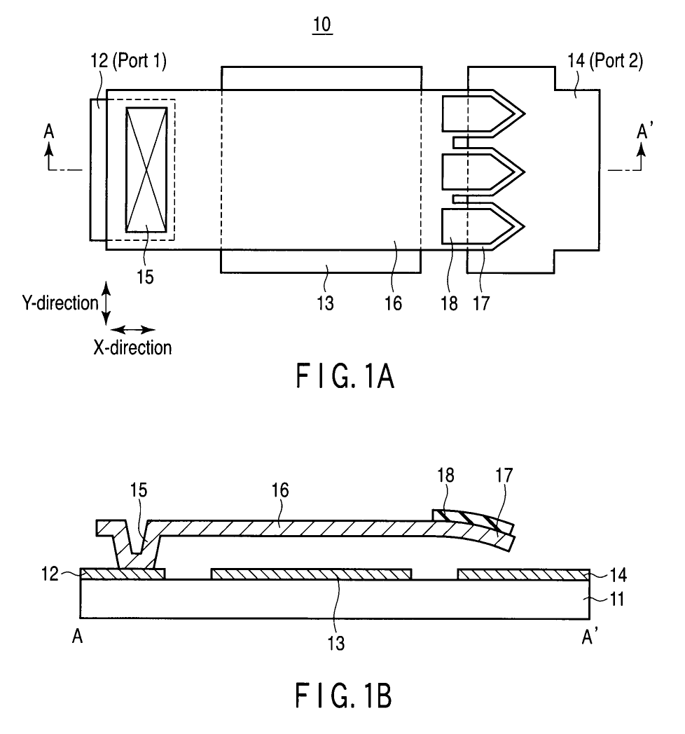

FIG. 1A is a plan view showing a configuration of a MEMS switch 10 according to a first embodiment. FIG. 1B is a cross-sectional view of the MEMS switch 10 taken along line A-A′ in FIG. 1A.

An insulating substrate 11 is formed of, e.g., a glass substrate or an insulating layer formed on a silicon substrate. Three electrodes 12, 13, and 14 are provided on the substrate 11. The three electrodes 12, 13, and 14 are aligned in an X-direction and electrically separated from each other. The electrode 12 is used for supplying a voltage to a movable structure 16, and corresponds to one electrode (a port 1) of a switch. The electrode 13 is used for driving the movable structure 16. The electrode 14 corresponds to the other electrode (a port 2) of the switch.

The movable structure 16 which moves downwards is provided above the electrode 13. The movable structure 16 is supported by an anchor 15 provided on the electrode 12. The movable structure 16 has a rectangular planar shape, and it is extended in the X-direction. The anchor 15 is electrically connected to the electrode 12. Each of the movable structure 16 and the anchor 15 is formed of, e.g., an electric conductor consisting of a metal or the like. Therefore, the movable structure 16 is electrically connected to the electrode 12.

For example, three contact members 17 are attached to an edge (a distal end in this embodiment) of the movable structure 16. Each contact member 17 is arranged above the electrode 14. Although the number of the contact members 17 varies depending on a size of the switch, this number is not restricted in particular, and it may be one or may be two or above. In this embodiment, the three contact members 17 are shown as an example. Each contact member 17 is formed of the same material as the movable structure 16.

The contact member 17 extends in the X-direction and a horizontal direction from the edge of the movable structure 16 and warps downwards, i.e., toward the electrode 14. The contact member 17 has a sharp planar shape and also has a claw shape. The claw shape is sharp and curved downwards. The warpage of the contact member 17 is realized by an adjustment film 18 provided on the contact member 17. The adjustment film 18 is provided to cover an upper surface of the contact member 17. The adjustment film 18 has larger compressible internal stress than that of the contact member 17. A material of the adjustment film 18 may be an insulator or an electric conductor as long as the internal stress conditions are met. A distance between the distal end of each contact member 17 and the electrode 14 is shorter than a distance between the movable structure 16 and the electrode 13 by an amount corresponding to the warpage of the contact member 17. This configuration does not have a dimple, and the distal end of the contact member 17 serves as a contact portion.

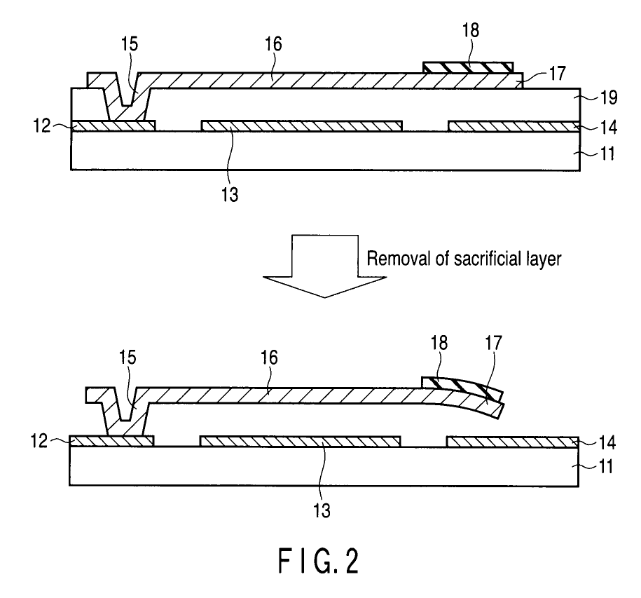

A manufacturing method of the MEMS switch 10 will be described. FIG. 2 is a cross-sectional view showing a manufacturing process of the MEMS switch 10.

First, a conductive layer is deposited on the substrate 11, and the conductive layer is patterned. Based on the patterning step, the electrodes 12, 13, and 14 are formed on the substrate 11. Subsequently, a sacrificial layer 19 is deposited on the substrate 11 and the electrodes 12, 13, and 14, and an upper surface of the sacrificial layer 19 is flattened.

Then, a conductive layer which is turned to the movable structure 16 and each contact member 17 is deposited on the sacrificial layer 19, and the conductive layer is patterned into a desired shape as shown in FIG. 1A. Subsequently, the anchor 15 that supports the movable structure 16 is formed on the electrode 12. Then, the adjustment film 18 is formed on each contact member 17.

Thereafter, when the sacrificial layer 19 is removed, the movable structure 16 is formed to maintain a substantially horizontal state. On the other hand, the contact member 17 warps downwards due to a difference in stress from the adjustment film 18. In this manner, each contact member 17 having a claw shape can be formed based on the very simple manufacturing method.

(Operation)

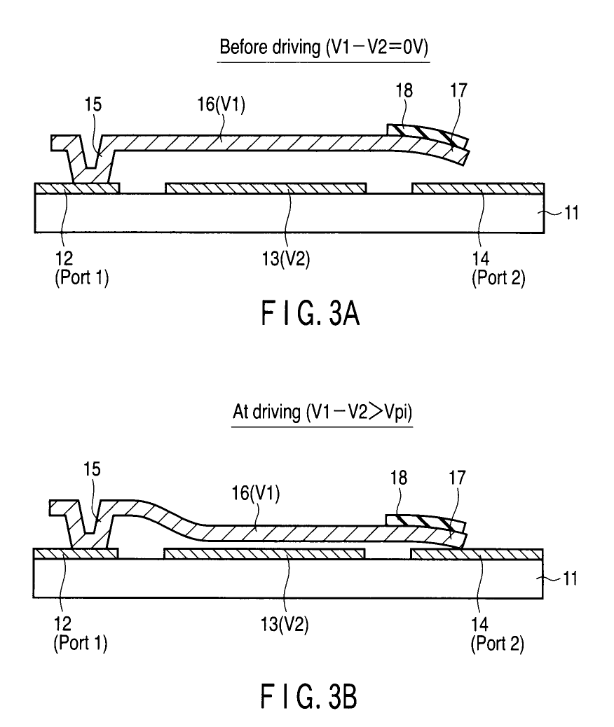

An operation of the MEMS switch 10 will now be described. FIGS. 3A and 3B are views for explaining an operation of the MEMS switch 10, and FIG. 3A shows a state of the MEMS switch 10 before driving while FIG. 3B shows a state of the same at the time of driving.

Before driving, a potential difference between a voltage V1 of the movable structure 16 and a voltage V2 of the electrode 13 is set to substantially 0 V. Therefore, the movable structure 16 is not drawn to the electrode 13, and it maintains a horizontal state. At this time, each contact member 17 is not in contact with the electrode 14, and electrical conduction is not achieved between a port 1 corresponding to the electrode 12 and a port 2 corresponding to the electrode 14. That is, the MEMS switch 10 is OFF.

At the time of driving, the potential difference between the voltage V1 of movable structure 16 and the voltage V2 of the electrode 13 is set to be larger than a predetermined pull-in voltage Vpi with which the movable structure 16 starts to move. Then, the movable structure 16 is drawn by the electrode 13 to move down, and the distal end of each contact member 17 is in contact with the electrode 14 in association with this movement. In this manner, at the time of driving, each contact member 17 is in contact with the electrode 14, and electrical conduction is achieved between port 1 and port 2. That is, the MEMS switch 10 is ON.

Here, since each contact member 17 has the claw shape, the distal end thereof alone is in contact with the electrode 14. Moreover, when the contact member 17 is in contact with the electrode 14, the distal end of the contact member 17 scratches a surface of the electrode 14. Therefore, a deposit on the contact portion of the contact member 17 and the electrode 14 can be removed. Additionally, since the distal end of the contact member 17 is sharp, force per unit area when the movable structure 16 moves downwards, i.e., force when the contact member 17 is in contact with the electrode 14 (contact force) intensifies. Therefore, contact resistance can be reduced without increasing a driving voltage.

### Example 1

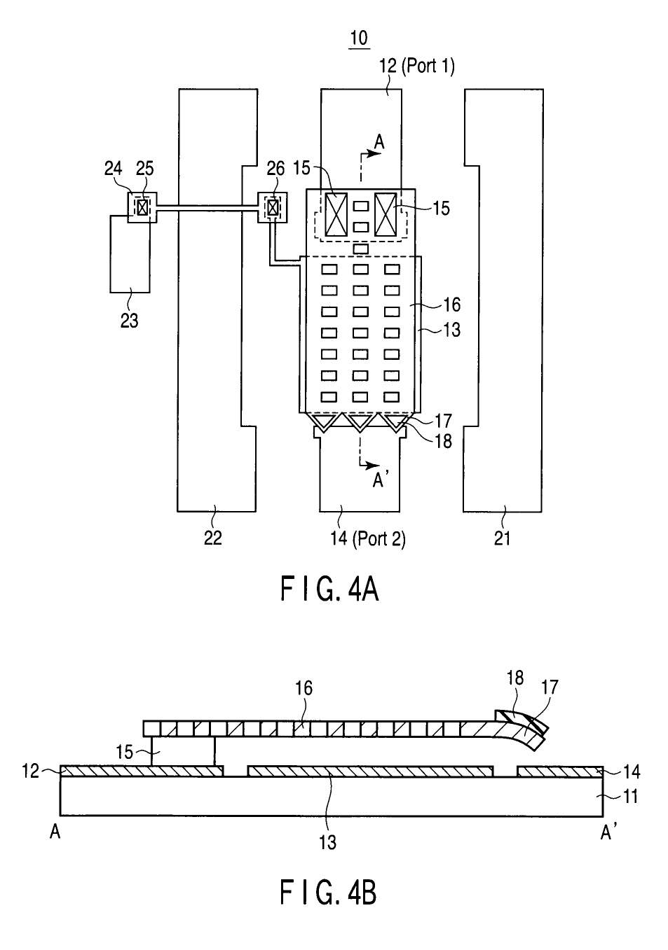

A specific example of the MEMS switch 10 will now be described. FIG. 4A is a plan view showing a configuration of a MEMS switch 10 according to Example 1. FIG. 4B is a cross-sectional view of the MEMS switch 10 taken along line A-A′ in FIG. 4A.

Configurations of a movable structure 16 and electrodes 12, 13, and 14 are the same as those in FIGS. 1A and 1B. It is to be noted that a plurality of openings provided in the movable structure 16 are used to completely remove a sacrificial layer from a lower side of the movable structure 16 in this manufacturing process.

Ground lines 21 and 22 are provided on a substrate 11 to surround the electrodes 12, 13, and 14 from both sides. The ground lines 21 and 22 are provided to configure coplanar type transmission lines.

A driving wiring line 23 through which a voltage is supplied to the electrode 13 is provided on the substrate 11. The driving wiring line 23 is electrically connected to the electrode 13 through a wiring line 24 and anchors 25 and 26 which are required to get across the ground line 22.

In Example 1, as shown in FIGS. 4A and 4B, contact members 17 are arranged at an end of the electrode 14. Therefore, an overlap area of the contact members 17 and the electrode 14 is small. This configuration has characteristics that an interelectrode capacitance when the MEMS switch 10 is OFF is small, i.e., isolation is excellent.

### Example 2

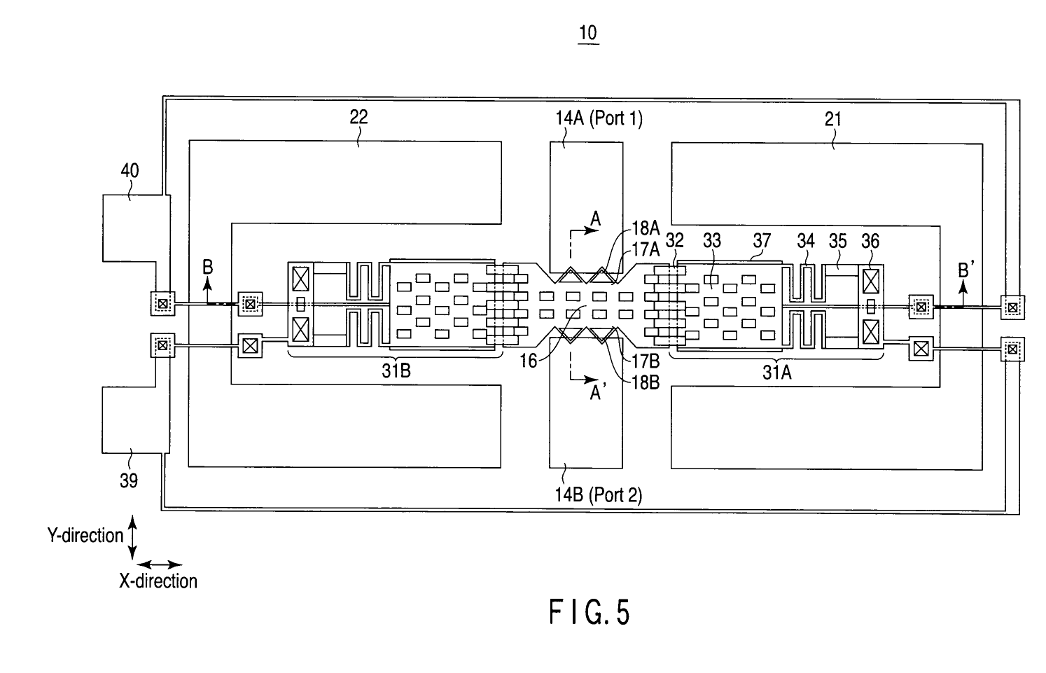

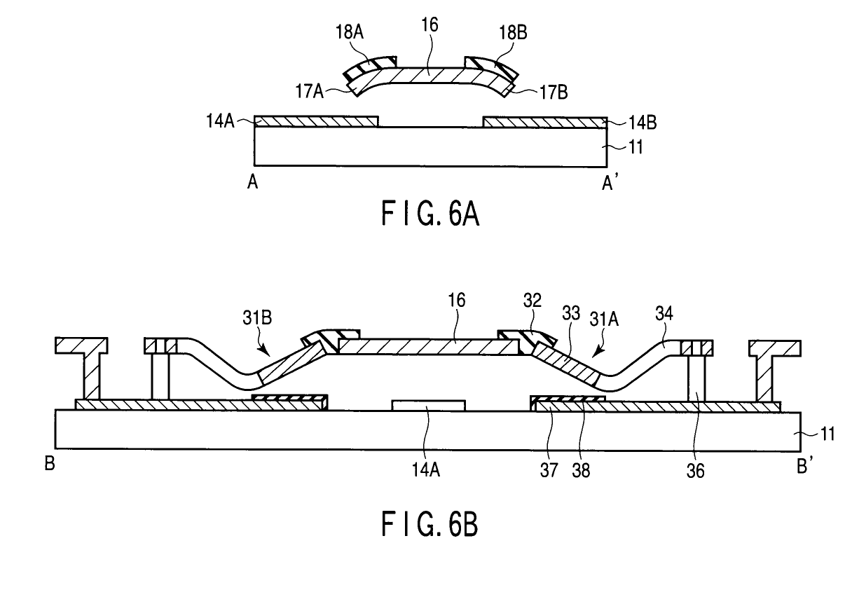

FIG. 5 is a plan view showing a configuration of a MEMS switch 10 according to Example 2. FIG. 6A is a cross-sectional view of the MEMS switch 10 taken along line A-A′ in FIG. 5. FIG. 6B is a cross-sectional view of the MEMS switch 10 taken along line B-B′ in FIG. 5.

Two electrodes 14A and 14B are aligned in a Y-direction, electrically separated from each other, and provided on a substrate 11. A movable structure 16 is extended in an X-direction, moves downwards, and is provided above the electrodes 14A and 14B.

For example, two contact members 17A are attached to one of ends on both sides of the movable structure 16 in the Y-direction. The two contact members 17A are arranged above the electrode 14A, respectively. An adjustment film 18A that is used to warp the contact member 17A toward the electrode 14A is provided on each contact member 17A. The contact member 17A has a sharp planar shape and also has a claw shape.

For example, two contact members 17B are attached to the other of the ends on both the sides of the movable structure 16 in the Y-direction. The two contact members 17B are arranged above the electrode 14B. An adjustment film 18B that is used to warp the contact member 17B toward the electrode 14B is provided on each contact member 17B. The contact member 17B has a sharp planar shape and also has a claw shape.

Both ends of the movable structure 16 in the X-direction are supported by two actuators 31A and 31B. Each actuator 31 is configured as follows. One end of an upper electrode 33 is connected to the movable structure 16 through insulating layers 32. That is, the movable structure 16 is electrically separated from the upper electrode 33. The other end of the upper electrode 33 is connected to anchors 36 provided on the substrate 11 through springs 34. A planar shape of the spring 34 is, e.g., a meander shape. An adjustment film 35 that adjusts the warpage of the spring 34 is provided at an end of each spring 34 on the anchor 36 side.

A lower electrode 37 is provided on the substrate 11 and below the upper electrode 33. An insulating film 38 is provided on the lower electrode 37 to prevent the lower electrode 37 from coming into contact with the upper electrode 33.

Further, as shown in FIG. 6B, the upper electrode 33 is arranged at a slant with respect to the substrate 11 to adjust a distance between the movable structure 16 and the electrode 14A. Specifically, the upper electrode 33 is arranged at a slant with respect to the lower electrode 37 (or the substrate 11) in such a manner that a distance from the lower electrode 37 becomes long as getting closer to the movable structure 16.

It is to be noted that the plurality of openings provided in the movable structure 16, the upper electrode 33, and the anchors 36 are utilized to completely remove a sacrificial layer from the lower side at these manufacturing steps.

The upper electrode 33 is electrically connected to a driving wiring line 39 through the wiring line and the anchor. The lower electrode 37 is electrically connected to a driving wiring line 40 through the wiring line and the anchor. A ground line 21 is provided on the substrate 11 to surround the actuator 31A. Likewise, a ground line 22 is provided on the substrate 11 to surround the actuator 31B. The ground lines 21 and 22 are provided to configure coplanar type transmission lines.

(Operation)

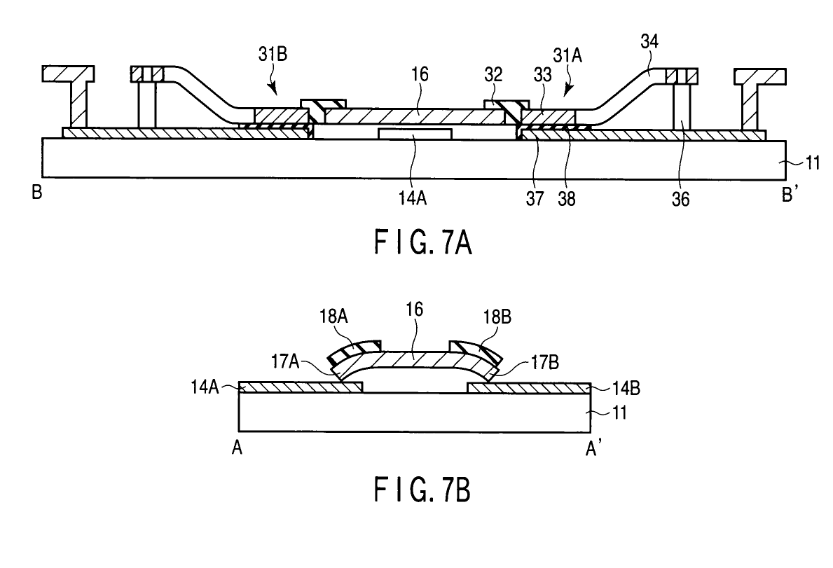

An operation of the MEMS switch 10 according to Example 2 will now be described. FIGS. 7A and 7B are views for explaining an operation of the MEMS switch 10, and FIG. 7A is a cross-sectional view of the MEMS switch 10 taken along line B-B′ in FIG. 5 while FIG. 7B is a cross-sectional view of the MEMS switch 10 taken along line A-A′ in FIG. 5.

In FIG. 5, the electrode 14A is a port 1 while the electrode 14B is a port 2, the MEMS switch 10 is OFF when port 1 and port 2 are not electrically conductive, and the MEMS switch 10 is ON when port 1 and port 2 are electrically conductive.

Before driving, a potential difference of the upper electrode 33 and the lower electrode 37 is set to 0V. A state of the MEMS switch 10 before driving is the same as that in FIG. 6A. Voltage application to the upper electrode 33 and the lower electrode 37 can be carried out by using the driving wiring lines 39 and 40. In this case, the upper electrode 33 is not drawn by the lower electrode 37, i.e., both the actuators 31A and 31B do not drive. At this time, the contact members 17 and the electrodes 14 are not in contact with each other, and port 1 and port 2 are not electrically conducted. That is, the MEMS switch 10 is OFF.

At the time of driving, the potential difference of the upper electrode 33 and the lower electrode 37 is set to be larger than a predetermined pull-in voltage Vpi. Then, the upper electrode 33 is drawn to the lower electrode 37 to move down, i.e., both the actuators 31A and 31B drive downwards. Further, as shown in FIGS. 7A and 7B, the movable structure 16 moves downwards in cooperation with the actuators 31A and 31B, and distal ends of the contact members 17A and 17B come into contact with the electrodes 14A and 14B, respectively. At this time, port 1 and port 2 are changed to be electrically conducted, and the MEMS switch 10 turns ON.

As explained above, in Example 2, the movable structure 16 having a center impeller structure can be used to configure the MEMS switch 10. Furthermore, when the actuators 31A and 31B are provided on both sides of the movable structure 16, the operation of the movable structure 16 is smoothened, thereby reducing a driving voltage.

### Example 3

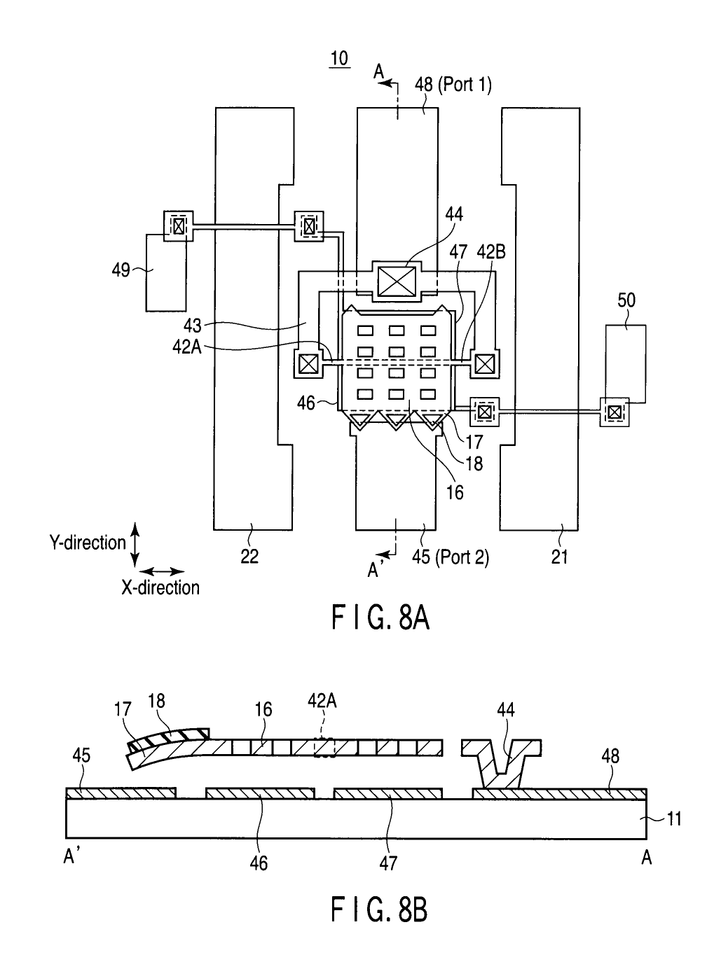

FIG. 8A is a plan view showing a configuration of a MEMS switch 10 according to Example 3. FIG. 8B is a cross-sectional view of the MEMS switch 10 taken along line A-A′ in FIG. 8A.

Four electrodes 45 to 48 which are aligned in the Y-direction and electrically separated from each other are provided on a substrate 11. A movable structure 16 is provided above the electrodes 46 and 47.

For example, three contact members 17 are attached to an end of the movable structure 16 in the X-direction. The three contact members 17 are arranged above the electrode 45. On each contact member 17, an adjustment film 18 which is used to warp the contact member 17 toward the electrode 45 is provided. The contact member 17 has a sharp planar shape and also has a claw shape.

Torsion bars 42A and 42B extended in the X-direction are disposed on both side surfaces of the movable structure 16 in the X-direction at the central part thereof. The torsion bars 42A and 42B are supported by a support member 43. A planar shape of the support member 43 is concave. Specifically, the support member 43 is constituted of first and second portions extended from ends of the torsion bars 42A and 42B in the Y-direction and a third portion which connects these first and second portions to each other and is extended in the X-direction. The support member 43 is fixed by an anchor 44 provided on the electrode 48. Each of the torsion bars 42A and 42B, the support member 43, and the anchor 44 is formed of a conductor, whereby the movable structure 16 is electrically connected to the electrode 48.

The electrode 47 is electrically connected to a driving wiring line 49 through a wiring line and the anchor. The electrode 46 is electrically connected to a driving wiring line 50 through a wiring line and the anchor. Ground lines 21 and 22 are provided on the substrate 11 and both sides of the electrodes 45 to 48 in the X-direction.

(Operation)

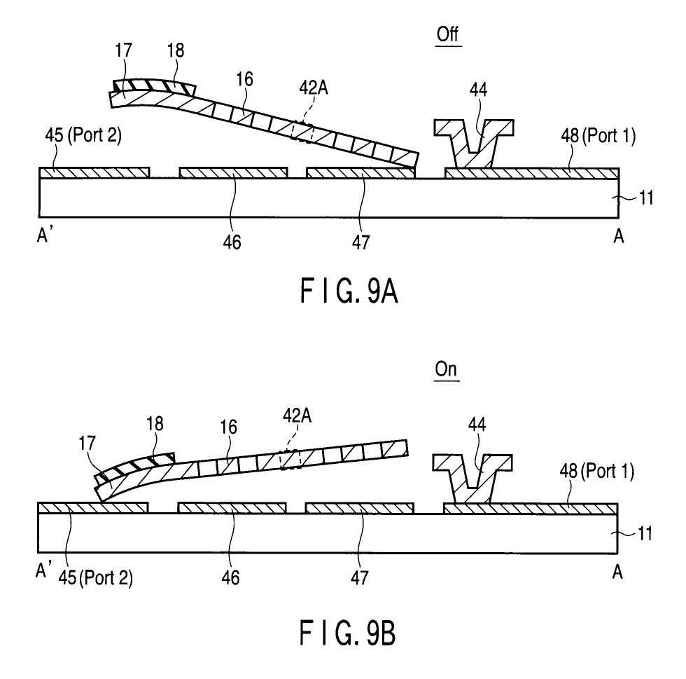

An operation of the MEMS switch 10 according to Example 3 will now be described. FIGS. 9A and 9B are cross-sectional views for explaining an operation of the MEMS switch 10, and FIG. 9A shows a state of the MEMS switch 10 which is OFF while FIG. 9B shows a state of the MEMS switch 10 which is ON.

When a potential difference is given between the driving wiring line 49 and a port 1 (the electrode 48), the movable structure 16 is drawn to the electrode 47, and the movable structure 16 inclines as shown in FIG. 9A. At this time, the contact member 17 is not in contact with the electrode 45, and port 1 corresponding to the electrode 48 and a port 2 corresponding to the electrode 45 are not electrically conductive. That is, the MEMS switch 10 is OFF.

On the other hand, when the potential difference is given between the driving wiring line 50 and port 1, the movable structure 16 is drawn to the electrode 46, and the movable structure 16 inclines as shown in FIG. 9B. At this time, each contact member 17 and the electrode 45 come into contact with each other, and electrical conduction is achieved between port 1 and port 2. That is, the MEMS switch 10 is ON.

In Example 3, as shown in FIG. 9A, OFF, a distance between each contact member 17 and the electrode 45 increases. As a result, in the MEMS switch 10 according to Example 3, isolation OFF can be increased.

### Example 4

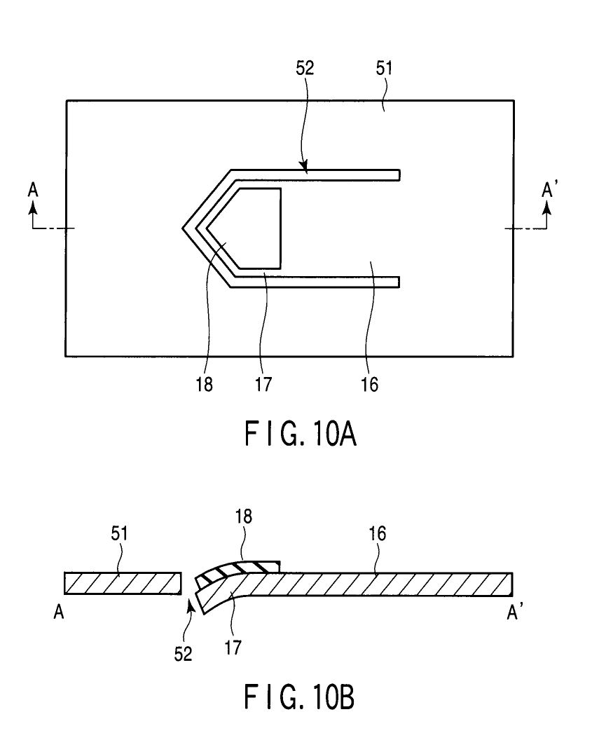

Example 4 is another structural example of the movable structure 16. FIG. 10A is a plan view showing configurations of a movable structure 16 and a contact member 17 according to Example 4. FIG. 10B is a cross-sectional view of the movable structure 16 and the contact member 17 taken along line A-A′ in FIG. 10A.

A notch 52 is formed in an electrode 51, and each of the movable structure 16 and the contact member 17 is formed to have a desired planar shape by using the notch 52. An adjustment film 18 which warps the contact member 17 to the lower side is provided on the contact member 17. The contact member 17 has a sharp planar shape and also has a claw shape.

The movable structure 16 and the contact member 17 can be formed like Example 4. It is to be noted that, when the movable structure 16 according to Example 4 is used, an electrode 13 that drives downward the movable structure 16 has substantially the same size as that of the movable structure 16 and is arranged below the movable structure 16. When such an electrode 13 is provided, the movable structure 16 and the contact member 17 can be driven downwards.

As explained above, according to this embodiment, each contact member 17 which is in contact with the electrode 14 when the MEMS switch 10 is ON is provided at the edge of the movable structure 16, and the adjustment film 18 having larger compressible internal stress than that of the contact member 17 is formed on the contact member 17. As a result, the contact member 17 can warp downwards. Further, when the planar shape of the contact member 17 is sharpened, the contact member 17 has the claw shape.

Therefore, according to this embodiment, when the contact member 17 is in contact with the electrode 14 arranged below the member, the distal end of the member alone is brought into contact with the electrode 14. As a result, contact resistance of the contact member 17 can be reduced, a loss of the MEMS switch can be decreased.

Furthermore, since each contact member 17 has a sharp distal end, force per unit area when the movable structure 16 moves downwards, i.e., a pressure when the contact member 17 is in contact with the electrode 14 can be intensified. Therefore, the contact resistance can be reduced without increasing a driving voltage.

Moreover, since the contact member 17 has the sharp distal end, the contact member 17 scratches the surface of the electrode 14 when the contact member 17 is in contact with the electrode 14. Consequently, a deposit on the contact portion of the contact member 17 and the electrode 14 can be removed, thereby avoiding an erroneous operation of the MEMS switch.

The MEMS switch according to this embodiment is particularly suitable for a high-frequency switch because of its characteristics, e.g., a small loss, good isolation, excellent linearity, and others.

It is to be noted that, when the MEMS switch according to this embodiment is used for a high frequency, using a conductor such as gold (Au) on which a natural oxide film is hardly formed as each of the movable structure 16, the contact member 17, and the electrode 14 is desirable. However, since the MEMS switch according to this embodiment performs the above-described scratch operation at the time of driving, natural oxide films formed on the contact member 17 and the electrode 14 can be removed. Therefore, even if a material such as aluminum (Al), copper (Cu), or nickel (Ni) other than gold (Au) is used as the movable structure 16, the contact member 17, and the electrode 14, a high-frequency switch having excellent characteristics can be configured.

### Second Embodiment

A second embodiment is an example where a MEMS structure according to the present invention is applied to an ESD (electrostatic discharge) protection device which is used to protect various kinds of circuits and elements from electrostatic discharge.

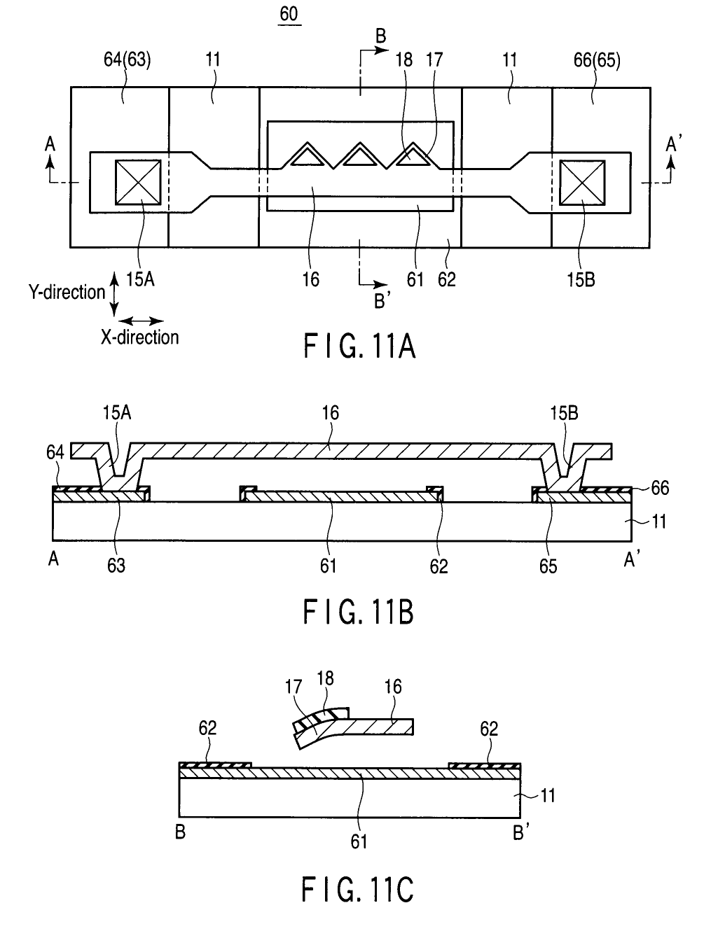

FIG. 11A is a plan view showing a configuration of an ESD protection device 60 according to the second embodiment of the present invention. FIG. 11B is a cross-sectional view of the ESD protection device 60 taken along line A-A′ in FIG. 11A. FIG. 11C is a cross-sectional view of the ESD protection device 60 taken along line B-B′ in FIG. 11A.

Three electrodes 63, 61, and 65 are provided on a substrate 11. The three electrodes 63, 61, and 65 are aligned in the X-direction and electrically separated from each other.

A movable structure 16 which is extended in the X-direction and moves downwards is provided above the electrode 61. One end of the movable structure 16 is supported by an anchor 15A provided on the electrode 63. The other end of the movable structure 16 is supported by an anchor 15B provided on the electrode 65. The anchors 15A and 15B are electrically connected to the electrodes 63 and 65, respectively. Each of the movable structure 16 and the anchors 15A and 15B is formed of a conductor such as a metal. Therefore, the movable structure 16 is electrically connected to the electrodes 63 and 65.

For example, three contact members 17 are attached to an edge (one side surface in the Y-direction in this embodiment) of the movable structure 16. The contact members 17 are arranged above the electrode 61. Although the number of the contact members 17 varies depending on a size of an ESD protection device 60, the number is not restricted in particular, and it may be one or may be two or above. In this embodiment, the three contact members 17 are exemplified. Each contact member 17 is formed of the same material as the movable structure 16.

The contact member 17 is extended in the Y-direction and the horizontal direction from the edge of the movable structure 16 and warps downwards, i.e., toward the electrode 61. Further, the contact member 17 has a sharp planar shape and also has a claw shape. The warpage of the contact member 17 is realized by the adjustment film 18 provided on each contact member 17. The adjustment film 18 has compressible internal stress larger than that of the contact member 17. A material of the adjustment film 18 may be an insulator or a conductor as long as the above-described internal stress conditions are met.

It is to be noted that a surface of the electrode 61 is covered with an insulating film 62 except a part which is in contact with the contact members 17. A surface of the electrode 63 is covered with an insulating film 64 except a part where the anchor 15A is formed. A surface of the electrode 65 is covered with an insulating film 66 except a part where the anchor 15B is formed.

The ESD protection device 60 is connected to a circuit as an ESD protection target in parallel to be utilized. That is, the electrode 63 is electrically connected to one end of a current path of the ESD protection target circuit. The electrodes 63 and 65 are electrically connected to the other end of the current path of the ESD protection target circuit.

[1] Example of Application to Variable Capacitance

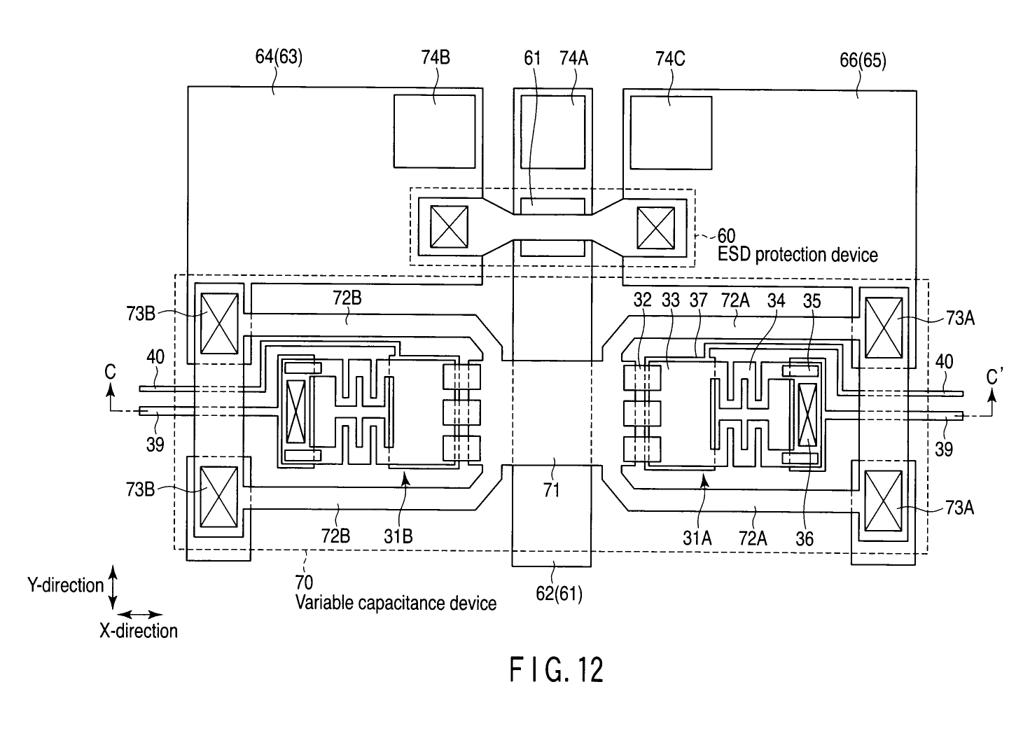

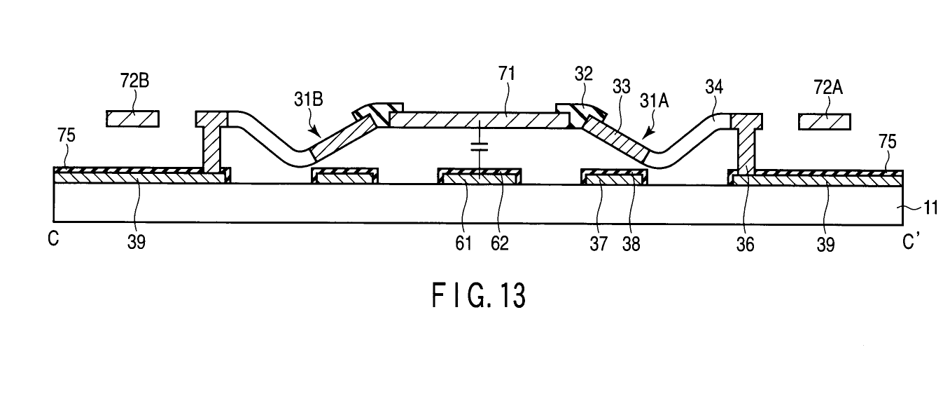

An application example of the ESD protection device 60 when a variable capacitance device is used as the ESD protection target circuit will now be described. FIG. 12 is a plan view showing configurations of the ESD protection device 60 and a variable capacitance device 70. FIG. 13 is a cross-sectional of the variable capacitance device 70 taken along line C-C′ in FIG. 12. It is to be noted that the ESD protection device 60 is simplified in FIG. 12 and an actual configuration of the ESD protection device 60 is as shown in FIGS. 11A to 11C.

A configuration of the variable capacitance device 70 will be first described. A signal line 61 extended in the Y-direction is provided on a substrate 11. A surface of the signal line 61 is covered with an insulating film 62. The signal line 61 corresponds to the electrode 61 in FIGS. 11A to 11C.

An electrode 71 which drives downwards is provided above the signal line 61. The electrode 71 has a rectangular planar shape and is extended in the X-direction. Both ends of the electrode 71 are supported by two actuators 31A and 31B. A configuration of each actuator 31 is the same as that in FIG. 5. An upper electrode 33 of the actuator 31 is electrically connected to a driving wiring line 39. A lower electrode 37 of the actuator 31 is electrically connected to a driving wiring line 40. Surfaces of the driving wiring lines 39 and 40 are covered with an insulating film 75. Driving of the actuator 31 is realized by applying a voltage to the driving wiring line 39 and the driving wiring line 40.

The electrode 71 is driven downwards by the actuators 31. A distance between the electrode 71 and the signal line 61 varies by such an operation of the electrode 71. In this manner, a capacitance of the variable capacitance device 70 can be changed.

One end of the electrode 71 is electrically connected to a ground line 65 through wiring lines 72A and conductive anchors 73A. Specifically, the wiring lines 72A are drawn out from the electrode 71 to be electrically connected to the ground line 65. The ground line 65 corresponds to the electrode 65 in FIGS. 11A and 11B.

Likewise, the other end of the electrode 71 is electrically connected to a ground line 63 through wiring lines 72B and conductive anchors 73B. Specifically, the wiring lines 72B are drawn out from the electrode 71 to be electrically connected to the ground line 63. The ground line 63 corresponds to the electrode 63 in FIGS. 11A and 11B.

The signal line 61 is electrically connected to a pad 74A. The ground line 63 is electrically connected to a pad 74B. The ground line 65 is electrically connected to a pad 74C. A predetermined voltage (a signal) is supplied to the signal line 61 through the pad 74A. The ground line 63 is grounded through the pad 74B. The ground line 65 is grounded through the pad 74C.

(Operation)

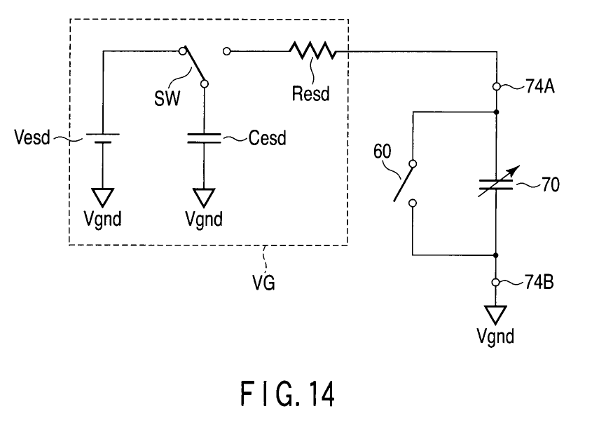

An operation of the ESD protection device 60 will now be described. FIG. 14 is an equivalent circuit schematic of the ESD protection device 60 and the variable capacitance device 70. The ESD protection device 60 is connected to the variable capacitance device 70 in parallel.

The pads (ground terminals) 74B and 74C are grounded, and a ground voltage Vgnd is applied. A voltage generation circuit VG that generates an ESD pulse is connected to the pad (a signal terminal) 74A.

A first terminal of a switch SW is connected to one electrode of a capacitance Cesd. The other electrode of the capacitance Cesd is grounded. A second terminal of the switch SW is connected to a power supply Vesd. A third terminal of the switch SW is connected to one end of a resistor Resd. The other end of the resistor Resd is connected to the signal terminal 74A. The capacitance Cesd is approximately 100 pF. The power supply Vesd is several kV. The resistor Resd is approximately 1.5 kΩ.

The ESD pulse is generated as follows. First, the power supply Vesd is connected to the capacitance Cesd by the switch SW so that the capacitance Cesd is charged with a voltage Vesd. Subsequently, the capacitance Cesd is connected to the resistor Resd by the switch SW. As a result, an electric charge stored in the capacitance Cesd is applied as the ESD pulse to the signal terminal 74A through the resistor Resd.

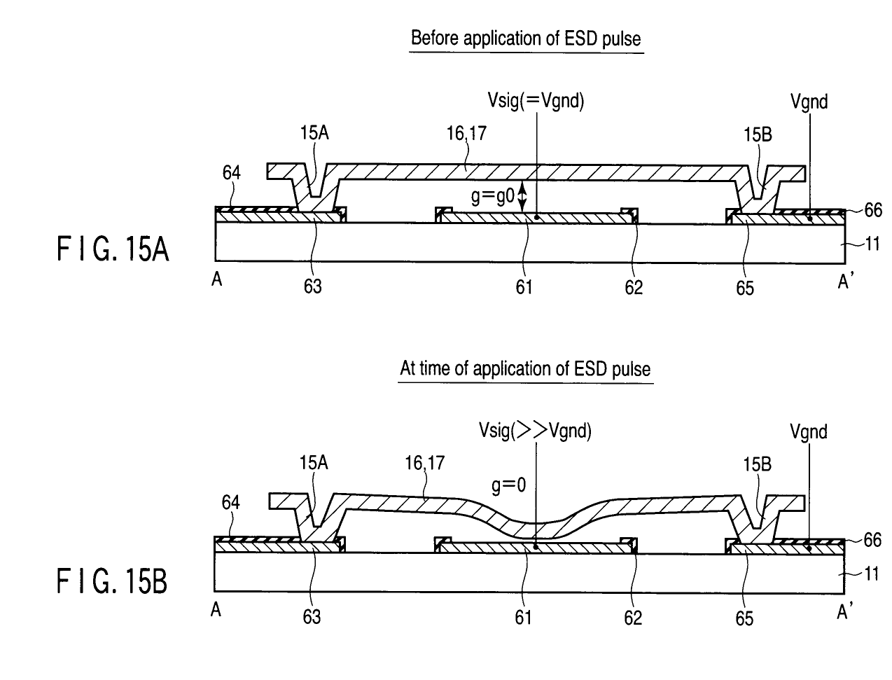

FIGS. 15A and 15B are views for explaining an operation of the ESD protection device 60, and FIG. 15A shows a state of the ESD protection device 60 before application of the ESD pulse while FIG. 15B shows a state of the same at the time of application of the ESD pulse.

Assuming that a voltage at the signal terminal 74A is Vsig, “Vsig=Vgnd” is achieved before application of the ESD pulse, and a potential difference between the movable structure 16 (and the contact member 17) and the signal line 61 is 0 V. Therefore, the movable structure 16 is not driven, and a distance g between the contact member 17 and the signal line 61 is an initial distance for which these members are apart from each other at a maximum (the distance is represented as g0). At this time, the contact member 17 is not in contact with the signal line 61, and the ESD protection device 60 is OFF.

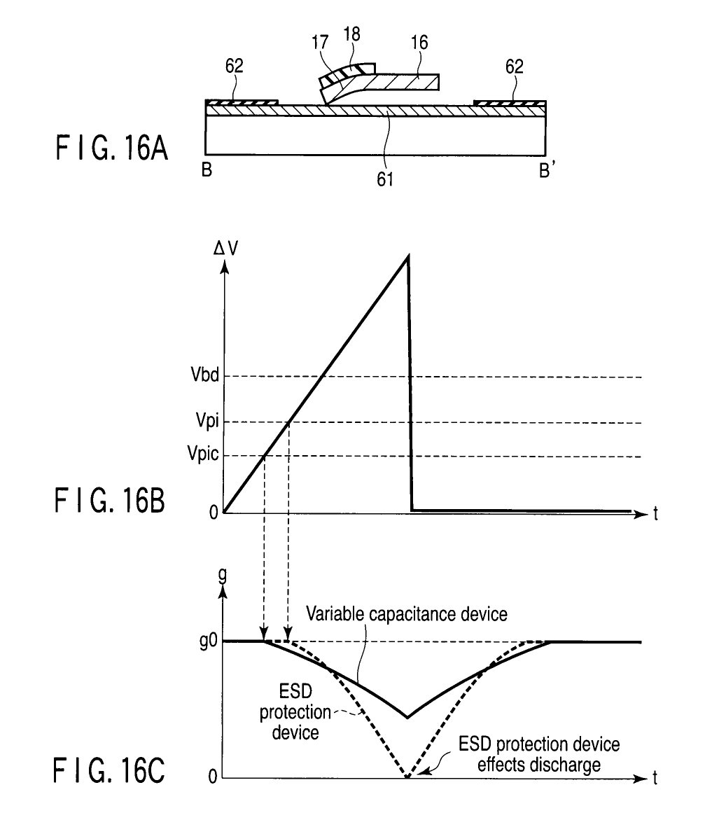

At the time of application of the ESD pulse, “Vsig>>Vgnd” or “Vsig<<Vgnd” is achieved, and the potential difference between the movable structure 16 (and the contact member 17) and the signal line 61 increases. Then, an electric field is concentrated on a distal point of each contact member 17, and the contact member 17 moves downwards. Further, the distal end of the contact member 17 is in contact with the signal line 61, and the distance g between the contact member 17 and the signal line 61 becomes zero. FIG. 16A is a view showing a state that the contact member 17 and the signal line 61 come into contact with each other at the time of application of the ESD pulse. At this moment, the ESD protection device 60 is ON.

FIGS. 16B and 16C are views showing a change in the distance g between the contact member 17 and the signal line 61 at the time of application of the ESD pulse. FIG. 16B shows a change in the ESD pulse. An abscissa in FIG. 16B represents a time t and an ordinate in the same represents a potential difference ΔV (=|Vsig−Vgnd|) between the signal terminal 74A and the ground terminal 74B (and 74C). FIG. 16C shows a change in distance between the contact member 17 of the ESD protection device 60 and the signal line 61 and a change in distance between the electrode 71 of the variable capacitance device 70 and the signal line 61. An abscissa in FIG. 16C represents a time t and an ordinate in the same represents a distance g between the contact member 17 (or the electrode 71) and the signal line 61. It is assumed that the distance g in the initial state (before driving) is g0 in both the ESD protection device 60 and the variable capacitance device 70.

“Vpic” shown in FIG. 16B is a pull-in voltage with which the electrode 71 of the variable capacitance device 70 starts to move. “Vpi” is a pull-in voltage with which the contact member 17 (or the movable structure 16) of the ESD protection device 60 starts to move. “Vbd” is a breakdown voltage of the ESD protection device 60. As shown in FIG. 12, an overlap area of the electrode 71 of the variable capacitance device 70 and the signal line 61 is larger than an overlap area of the movable structure 16 of the ESD protection device 60 and the signal line 61. Therefore, a capacitance of the variable capacitance device 70 is higher than that of the ESD protection device 60. Therefore, the pull-in voltage Vpic of the variable capacitance device 70 is higher than the pull-in voltage Vpi of the ESD protection device 60.

When the ESD pulse is applied to the signal terminal 74A, a potential difference ΔV precipitously increases. Further, when the potential difference ΔV reaches the pull-in voltage Vpic, the electrode 71 of the variable capacitance device 70 starts to move. Then, when the potential difference ΔV reaches the pull-in voltage Vpi, each contact member 17 (and the movable structure 16) of the ESD protection device 60 starts to move.

Here, in the ESD protection device 60, as shown in FIG. 12, a width of the movable structure 16 (a length in the Y-direction) is set to be smaller than a width of the electrode 71 (a length in the Y-direction). That is, an area of the movable structure 16 is smaller than an area of the electrode 71. Therefore, the movable structure 16 has air resistance smaller than that of the electrode 71, and hence the movable structure 16 moves downwards quickly as compared with the electrode 71. Furthermore, when the potential difference ΔV exceeds the breakdown voltage Vbd, each contact member 17 is in contact with the signal line 61. At this time, the ESD protection device 60 discharges the signal terminal 74A to the ground terminal 74B. As a result, the voltage Vsig at the signal terminal 74A returns to the ground voltage Vgnd.

Even when the ESD pulse is applied to the signal terminal 74A in this manner, the variable capacitance device 70 can be prevented from being destroyed. Moreover, since a contact area of each contact member 17 and the signal line 61 is small, a stiction failure hardly occurs. Additionally, since a distance between each contact member 17 and the signal line 61 is large in the initial state, a parasitic capacitance of the ESD protection device 60 can be reduced.

Further, since the contact member 17 is in contact with the signal line 61 in a point, the contact member 17 can readily move apart from the signal line 61 when the potential difference ΔV becomes zero. As a result, the ESD protection device 60 according to this embodiment has characteristics that it is hardly destroyed even when the ESD pulse is applied.

[2] Example of Application to MEMS Switch

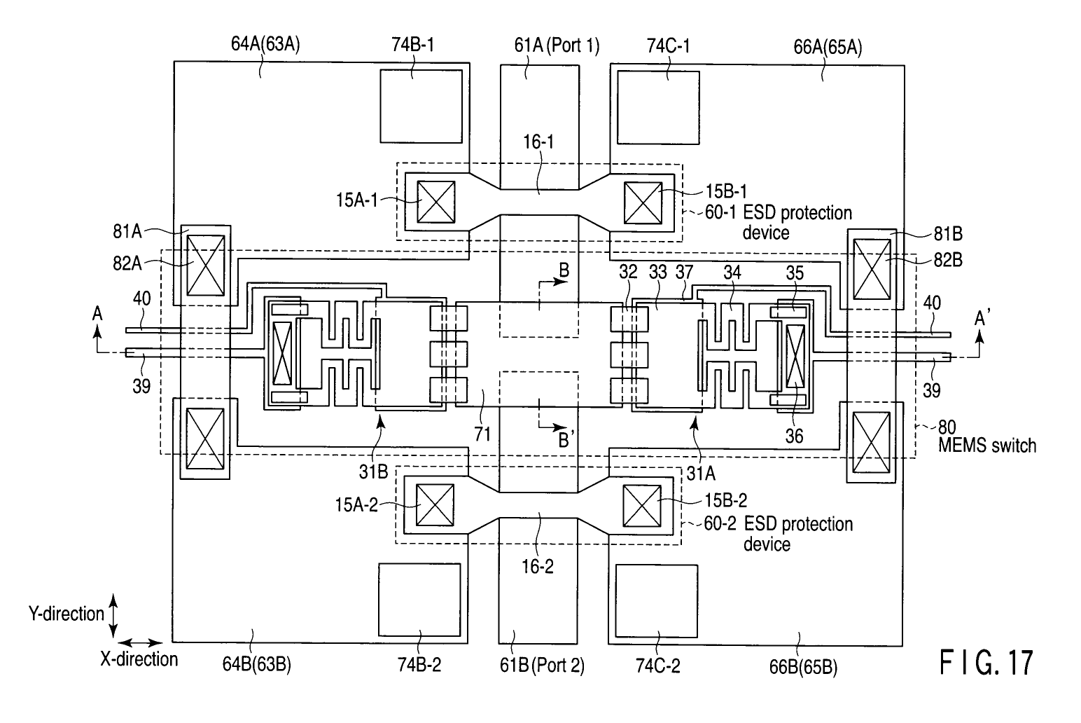

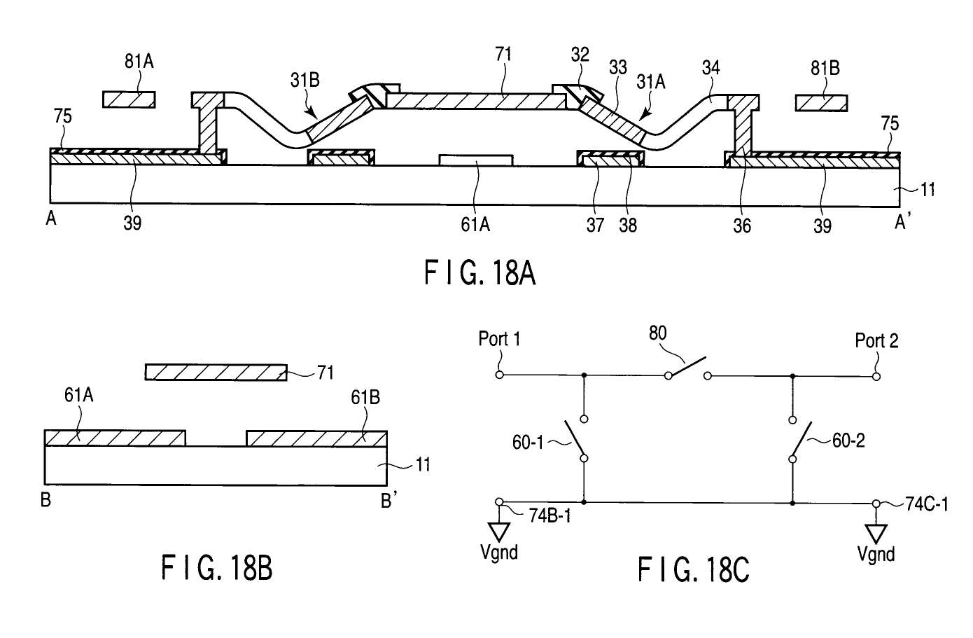

An application example of the ESD protection device 60 when a MEMS switch is used as an ESD protection target circuit will now be described. FIG. 17 is a plan view showing configurations of each of the ESD protection device 60 and a MEMS switch 80. FIG. 18A is a cross-sectional view of the MEMS switch 80 taken along line A-A′ in FIG. 17. FIG. 18B is a cross-sectional view of the MEMS switch 80 taken along line B-B′ in FIG. 17.

A configuration of the MEMS switch 80 will be first explained. Electrodes 61A and 61B which are aligned in the Y-direction and electrically separated from each other are provided on a substrate 11. An electrode 71 which is driven down is provided above the electrodes 61A and 61B. The electrode 71 has a rectangular planar shape and is extended in the X-direction. Both ends of the electrode 71 are supported by two actuators 31A and 31B, respectively. A configuration and an operation of each actuator 31 are the same as that of the actuator in FIG. 12.

The electrode 71 is driven downwards by the actuators 31. Further, when the electrode 71 is in contact with the electrodes 61A and 61B, electrical conduction is achieved between the electrodes 61A and 61B. In this manner, ON and OFF of the MEMS switch 80 can be switched.

ESD protection devices 60-1 and 60-2 are provided on both sides of the MEMS switch 80 in the Y-direction. It is to be noted that each ESD protection device 60 is simplified in FIG. 17, and an actual configuration of the ESD protection device 60 is as shown in FIGS. 11A to 11C.

A movable structure 16-1 of the ESD protection device 60-1 is arranged above the electrode 61A. An anchor 15A-1 of the ESD protection device 60-1 is provided on a ground line 63A to be electrically connected to the ground line 63A. An anchor 15B-1 of the ESD protection device 60-1 is provided on a ground line 65A to be electrically connected to the ground line 65A.

The ground line 63A is electrically connected to a pad 74B-1. The ground line 65A is electrically connected to a pad 74C-1. The ground line 63A is grounded through the pad 74B-1. The ground line 65A is grounded through the pad 74C-1. Surfaces of the ground lines 63A and 65A are covered with insulating films 64A and 66A, respectively.

A movable structure 16-2 of the ESD protection device 60-2 is arranged above the electrode 61B. An anchor 15A-2 of the ESD protection device 60-2 is provided on a ground line 63B to be electrically connected to the ground line 63B. An anchor 15B-2 of the ESD protection device 60-2 is provided on a ground line 65B to be electrically connected to the ground line 65B.

The ground line 63B is electrically connected to a pad 74B-2. The ground line 65B is electrically connected to a pad 74C-2. The ground line 63B is grounded through the pad 74B-2. The ground line 65B is grounded through the pad 74C-2. Surfaces of the ground lines 63B and 65B are covered with insulating films 64B and 66B, respectively.

The ground lines 63A and the ground line 63B are electrically connected to each other through two anchors 82A and a wiring line 81A. The ground line 65A and the ground line 65B are electrically connected to each other through two anchors 82B and a wiring line 81B.

FIG. 18C is an equivalent circuit schematic of the MEMS switch 80 and each ESD protection device 60. A first terminal of the MEMS switch 80 is connected to a port 1 (the electrode 61A). A second terminal of the MEMS switch 80 is connected to a port 2 (the electrode 61B).

A first terminal of the ESD protection device 60-1 is connected to port 1. A second terminal of the ESD protection terminal 60-1 is grounded through the pad (a ground terminal) 74B-1. A first terminal of the ESD protection device 60-2 is connected to port 2. A second terminal of the ESD protection terminal 60-2 is grounded through the pad (a ground terminal) 74C-1.

Based on such a circuit configuration, when an ESD pulse is applied to port 1, the ESD protection device 60-1 is turned on. Therefore, the ESD protection device 60-1 discharges port 1 to the ground terminal 74B-1. Likewise, when the ESD pulse is applied to port 2, the ESD protection device 60-2 is turned on. Accordingly, the ESD protection device 60-2 discharges port 2 to the ground terminal 74C-1. As a result, the ESD pulse can be used to prevent the MEMS switch 80 from being destroyed.

### Example 1

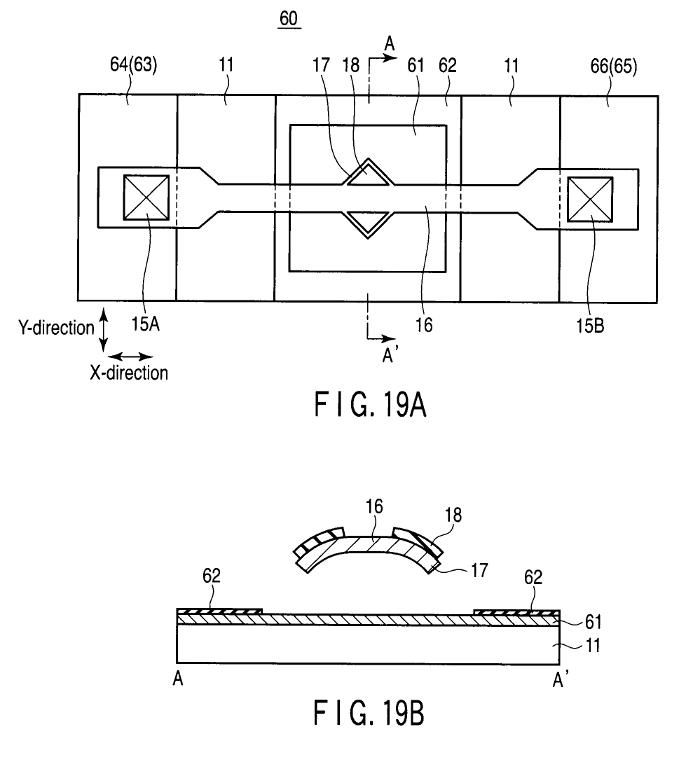

Another structural example of the ESD protection terminal 60 will now be described. FIG. 19A is a plan view showing a configuration of an ESD protection device 60 according to Example 1. FIG. 19B is a cross-sectional view of the ESD protection device 60 taken along line A-A′ in FIG. 19A.

A movable structure 16 which is extended in the X-direction and moves downwards is provided above an electrode 61. One end of the movable structure 16 is supported by an anchor 15A provided on an electrode 63. The other end of the movable structure 16 is supported by an anchor 15B provided on an electrode 65. The movable structure 16 is electrically connected to the electrodes 63 and 65 through the anchors 15A and 15B.

Contact members 17 are provided on both side surfaces of the movable structure 16 in the Y-direction, respectively. Each contact member 17 is arranged above the electrode 61. Each contact member 17 is extended in the Y-direction and a horizontal direction from an end of the movable structure 16 and warps toward the electrode 61. The contact member 17 has a sharp planar shape and also has a claw shape. Since the planar shape is sharp, an electric field in the sharp portion intensifies. Therefore, ESD discharge tends to occur in the sharp portion. The warpage of the contact member 17 is realized by an adjustment film 18 provided on each contact member 17.

Even when the ESD protection device 60 is configured in this manner, the device can perform the same operation as the ESD protection device 60 in FIGS. 11A to 11C, and the same effects can be obtained.

### Example 2

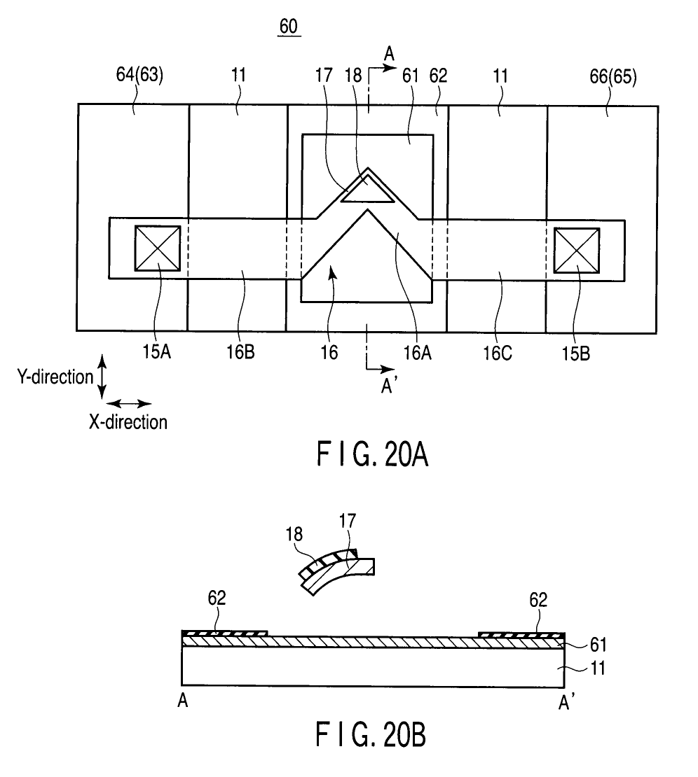

FIG. 20A is a plan view showing a configuration of an ESD protection device 60 according to Example 2. FIG. 20B is a cross-sectional view of the ESD protection device 60 taken along line A-A′ in FIG. 20A.

A central portion of a movable structure 16 has a V-shape whose planar shape protrudes in the Y-direction. A distal end of the V-shaped portion 16A corresponds to a contact member 17. That is, the movable structure 16 is formed of the V-shaped portion 16A and two rectangular portions 16B and 16C extended from both ends of the portion in the X-direction. The rectangular portion 16B is supported by an anchor 15A. The rectangular portion 16C is supported by an anchor 15B.

The contact member 17 is arranged above an electrode 61. Further, the contact member 17 is extended in the Y-direction and the horizontal direction and warps toward the electrode 61. The contact portion member 17 has a sharp planar shape and also has a claw shape. The warpage of the contact member 17 is realized by an adjustment film 18 provided on the contact member 17.

In the ESD protection device 60 according to Example 2, the movable structure 16 does not have a linear shape but it partially has a V-shape. Therefore, a spring constant of the movable structure 16 is smaller than that of the linear movable structure. As a result, the contact member 17 can readily move down, whereby a voltage with which the ESD protection device 60 is turned on can be reduced.

### Example 3

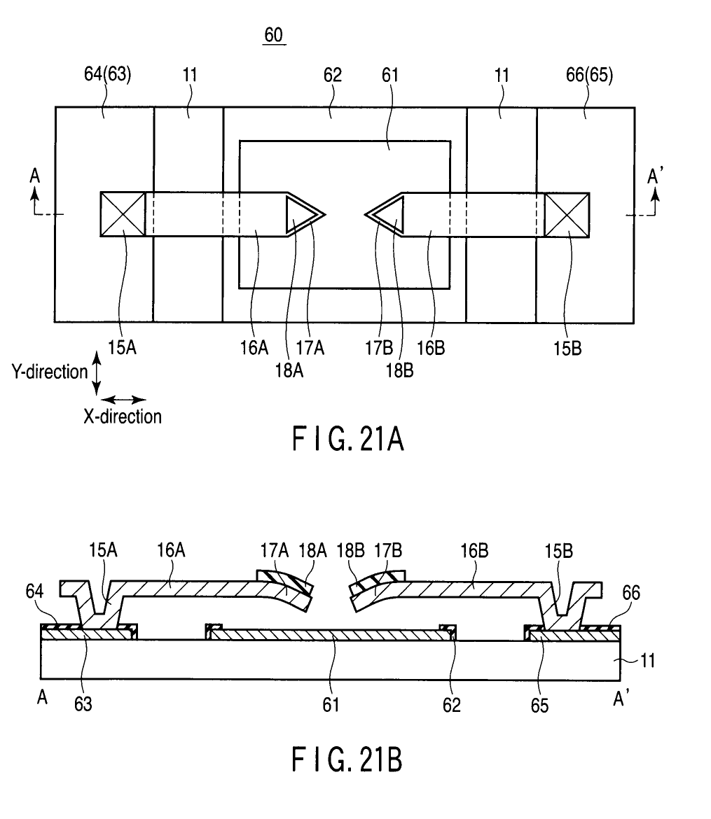

FIG. 21A is a plan view showing a configuration of an ESD protection device 60 according to Example 3. FIG. 21B is a cross-sectional view of the ESD protection device 60 taken along line A-A′ in FIG. 21A.

A movable structure 16A which is extended in the X-direction and moves downwards is provided above an electrode 61. One end of the movable structure 16A is supported by an anchor 15A provided on an electrode 63. That is, the movable structure 16A has a cantilever structure. A contact member 17A is provided at a distal end of the movable structure 16A. The contact member 17A is arranged above the electrode 61. Furthermore, the contact member 17A is extended from the distal end of the movable structure 16A in the Y-direction and the horizontal direction and warps toward the electrode 61. The contact member 17A has a sharp planar shape and also has a claw shape. The warpage of the contact member 17A is realized by an adjustment film 18A provided on the contact member 17A.

Likewise, a movable structure 16B which is extended in the X-direction and moves downwards is provided above the electrode 61. One end of the movable structure 16B is supported by an anchor 15B provided on an electrode 65. A contact member 17B is provided at a distal end of the movable structure 16B. The contact member 17B is extended from the distal end of the movable structure 16B in the Y-direction and the horizontal direction and warps toward the electrode 61. The contact member 17B has a sharp planar shape and also has a claw shape. The warpage of the contact member 17B is realized by an adjustment film 18B provided on the contact member 17B. The contact member 17B is arranged above the electrode 61 to face the contact member 17A.

In the ESD protection device 60 according to Example 3, each of the movable structures 16A and 16B has the cantilever structure. Therefore, a spring constant of each movable structure is smaller than that of a center impeller type movable structure. As a result, the contact members 17A and 17B can readily move down, whereby a voltage with which the ESD protection device 60 is turned on can be reduced.

As explained above, according to this embodiment, the contact member 17 which is in contact with the electrode 61 when the ESD pulse is applied to the ESD protection device 60 is attached to the edge of the movable structure 16, and the adjustment film 18 having large compressible internal stress than that of the contact member 17 is formed on the contact member 17. As a result, the contact member 17 is configured to warp downwards. Moreover, the contact member 17 has the claw shape by sharpening the planar shape of the contact member 17.

Therefore, according to this embodiment, connecting the ESD protection device 60 having the claw-shaped contact member 17 to the ESD protection target circuit in parallel enables the ESD protection device 60 to effect discharge to the ground terminal when the ESD pulse is applied to the ESD protection target circuit. As a result, even when the ESD pulse is applied to the ESD protection target circuit, the EDS protection target circuit can be prevented from being destroyed.

Additionally, when the contact member 17 is in contact with the electrode 61 arranged below itself, the distal end thereof alone is brought into contact with the electrode 14. As a result, a stiction failure of the ESD protection device 60 can be avoided.

Further, since the distance between the contact member 17 and the electrode 61 is large before application of the ESD pulse, a parasitic capacitance of the ESD protection device 60 can be reduced. As a result, even when the ESD protection device 60 is connected to the ESD protection target circuit in parallel, an influence on circuit characteristics can be decreased.

Furthermore, since the contact member 17 is in contact with the electrode 61 in a point, the contact member 17 and the signal line 61 can readily move away from each other when a potential difference between them becomes zero. Consequently, the ESD protection device 60 according to this embodiment has characteristics that it is hardly destroyed even though the ESD pulse is applied thereto.

It is to be noted that, as the ESD protection target circuit, various circuits can be utilized in addition to the variable capacitance device and the MEMS switch. For example, a CMOS circuit may be used as the ESD protection target circuit.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A switch comprising:
a first electrode provided on a substrate;
an anchor provided on the substrate;
a movable structure which is supported by the anchor, provided above the first electrode to be extended from the anchor in a direction, formed of a conductor, and moves downwards; and
a contact member which is attached to an edge of the movable structure, formed of a conductor, and warps toward the first electrode.

2. The switch according to claim 1, further comprising an adjustment film which is provided on the contact member and has a stress difference from a material of the contact member.

3. The switch according to claim 1, wherein a planar shape of the contact member is sharp.

4. The switch according to claim 1, wherein the contact member is sharp and curved downwards.

5. The switch according to claim 3, wherein the sharp edge of the contact member is in contact with the first electrode at ON-state.

6. The switch according to claim 1, wherein the contact member is continuous to the movable structure.

7. The switch according to claim 1, wherein the contact member has an uniform thickness, and an edge of the contact member faces toward the first electrode.

8. The switch according to claim 1, further comprising a second electrode which is provided on the substrate and below the movable structure, and drives the movable structure.

9. A switch comprising:
first and second electrodes provided on a substrate to be aligned in a first direction;
a movable structure which is provided above the first and second electrodes to be extended in a second direction orthogonal to the first direction, and formed of a conductor;
first and second contact members which are respectively attached to both ends of the movable structure in the first direction, formed of a conductor, and respectively warp toward the first and second electrodes; and
first and second actuators which are respectively attached to both ends of the movable structure in the second direction, and drive downwards the movable structure.

10. The switch according to claim 9, further comprising an adjustment film which is provided on the first and second contact members and has a stress difference from a material of the first and second contact members.

11. The switch according to claim 9, wherein a planar shape of the first and second contact members is sharp.

12. The switch according to claim 9, wherein the first and second contact members is sharp and curved downwards.

13. The switch according to claim 11, wherein
the sharp edge of the first contact member is in contact with the first electrode at ON-state, and
an end of the second contact member is in contact with the second electrode at ON-state.

14. An ESD protection device comprising:
an electrode which is provided on a substrate and electrically connected to a first terminal of a current path of a device to be protected;
a first anchor provided on the substrate;
a movable structure which is supported by the first anchor, provided above the electrode to be extended from the first anchor in a first direction, formed of a conductor, moves downwards, and is electrically connected to a second terminal of the current path of the device to be protected; and
a contact member which is attached to an edge of the movable structure, formed of a conductor, and warps toward the electrode.

15. The device according to claim 14, further comprising an adjustment film which is provided on the contact member and has a stress difference from a material of the contact member.

16. The device according to claim 14, wherein a planar shape of the contact member is sharp.

17. The device according to claim 14, wherein the contact member is sharp and curved downwards.

18. The device according to claim 15, wherein the sharp edge of the contact member is in contact with the electrode when an ESD pulse is applied, and is not in contact with the electrode when the ESD pulse is not applied.

19. The device according to claim 14, further comprising a second anchor provided on the substrate,
wherein the first and second anchors support the movable structure on both sides in the first direction.

20. The device according to claim 19, wherein the contact member is attached to an end of the movable structure in a second direction orthogonal to the first direction.
